(19) United States
(12) Patent Application Publication
(10) Pub. No.: US 2026/0051611 A1
(43) Pub. Date: Feb. 19, 2026

(54) VENT GAS DIVERTER FOR RECHARGEABLE ENERGY STORAGE SYSTEM OF VEHICLE

(71) Applicant: GM GLOBAL TECHNOLOGY OPERATIONS LLC, DETROIT, MI (US)

(72) Inventors: Derek Frei Lahr, Ann Arbor, MI (US); Xiaoling Chen, Sterling Heights, MI (US); Ashok Kumar Maruthai, Bangalore (IN); Kothamasi Sumithra Raju, Bangalore (IN); Ronald O. Grover, JR., Northville, MI (US); SeungHwan Keum, Northville, MI (US)

(21) Appl. No.: 18/808,587

(22) Filed: Aug. 19, 2024

(51) Int. Cl. H01M 50/358; H01M 50/249; H01M 50/383

(52) U.S. Cl. CPC H01M 50/358; H01M 50/249; H01M 50/383

(57) ABSTRACT

A rechargeable energy storage system (RESS) of a vehicle includes a plurality battery cells. The plurality of battery cells includes a plurality of cell vents to exhaust hot vent gas from the plurality of battery cells. A diverter is positioned at at least one cell vent of the plurality of cell vents and defines a diverter chamber. The diverter includes one or more diverter openings to direct the vent gas in one or more selected directions.

The subject disclosure relates to vehicles, and in particular rechargeable energy storage systems (RESS) for vehicles.

Many vehicles include RESS structures to provide power to, for example, propulsion systems of the vehicle. RESS structures typically include a plurality of battery cells. Under certain conditions, the battery cells may release high temperature gas (i.e., vent gas from a battery cell). This high temperature vent gas causes a thermal propagation event for the nearby component surfaces such as the battery cover. It is desired to control and direct the flow of the vent gas from the battery cells in a preselected direction away from the battery cell.

### SUMMARY

In one exemplary embodiment, a rechargeable energy storage system (RESS) of a vehicle includes a plurality battery cells. The plurality of battery cells includes a plurality of cell vents to exhaust hot vent gas from the plurality of battery cells. A diverter is positioned at at least one cell vent of the plurality of cell vents and defines a diverter chamber. The diverter includes one or more diverter openings to direct the vent gas in one or more selected directions.

In addition to one or more of the features described herein the diverter includes a diverter sidewall and a diverter cap. The one or more diverter openings are positioned in the diverter sidewall.

In one exemplary embodiment, a rechargeable energy storage system (RESS) of a vehicle includes a plurality of battery cells, the plurality of battery cells including a plurality of vent openings to exhaust hot vent gas from the plurality of battery cells. A diverter is positioned at at least one cell vent of the plurality of cell vents and defining a diverter chamber. The diverter includes one or more diverter openings to direct the hot vent gas in one or more selected directions.

In addition to one or more of the features described herein the diverter includes a diverter sidewall and a diverter cap. The one or more diverter openings are positioned in the diverter sidewall.

In addition to one or more of the features described herein a protrusion extends from the diverter cap toward a vent opening of the plurality of vent openings. The protrusion is configured to control a chamber velocity of the vent gas.

In addition to one or more of the features described herein the protrusion is conical in shape.

In addition to one or more of the features described herein the diverter spans two or more vent openings of the plurality of vent openings.

In addition to one or more of the features described herein the diverter is an inclined panel positioned at the two or more vent openings.

In addition to one or more of the features described herein the inclined panel has a first panel distance from the battery cells to the inclined panel at a vent opening of the two or more vent openings greater than a second panel distance from the battery cells to the inclined panel between the two or more vent openings.

In addition to one or more of the features described herein the inclined panel is secured to the two or more battery cells at at least one panel end.

In addition to one or more of the features described herein the diverter includes a top wall and two opposing side walls. The top wall and side walls define the diverter chamber and the one or more diverter openings. The top wall includes at least one top wall opening configured to admit relatively cool ambient airflow into the diverter chamber for mixing with the hot vent gas.

In addition to one or more of the features described herein a flow guide is positioned in the at least one top wall opening to guide the ambient airflow thereinto.

In another exemplary embodiment, a vehicle includes a vehicle body, a powertrain located in the vehicle body, and a rechargeable energy storage system (RESS) operably connected to the powertrain. The RESS includes a plurality of battery cells, the plurality of battery cells including a plurality of vent openings to exhaust hot vent gas from the plurality of battery cells. A diverter is positioned at at least one vent opening of the plurality of vent openings and defines a diverter chamber. The diverter includes one or more diverter openings to direct the hot vent gas in one or more selected directions.

In addition to one or more of the features described herein the diverter includes a diverter sidewall and a diverter cap. The one or more diverter openings are positioned in the diverter sidewall.

In addition to one or more of the features described herein a protrusion extends from the diverter cap toward a vent opening of the plurality of vent openings. The protrusion is configured to control a chamber velocity of the vent gas.

In addition to one or more of the features described herein the protrusion is conical in shape.

In addition to one or more of the features described herein the diverter spans two or vent openings of the plurality of vent openings.

In addition to one or more of the features described herein the diverter is an inclined panel positioned at the two or more vent openings.

In addition to one or more of the features described herein the inclined panel has a first panel distance from the battery cells to the inclined panel at a vent opening of the two or more vent openings greater than a second panel distance from the battery cells to the inclined panel between the two or more vent openings.

In addition to one or more of the features described herein the inclined panel is secured to the battery cells at at least one panel end.

In addition to one or more of the features described herein the diverter includes a top wall and two opposing side walls. The top wall and side walls defining the diverter chamber and the one or more diverter openings. The top wall includes at least one top wall opening configured to admit relatively cool ambient airflow into the diverter chamber for mixing with the hot vent gas.

In yet another exemplary embodiment, a vehicle includes a vehicle body defining a passenger compartment, a powertrain positioned at the vehicle body, and a rechargeable energy storage system (RESS) operably connected to the powertrain. The RESS includes a plurality of battery cells, the plurality of battery cells including a plurality of vent openings to exhaust hot vent gas from the plurality of battery cells. A diverter is positioned at at least one vent opening of the plurality of vent openings and defines a diverter chamber. The diverter includes one or more diverter openings to direct the hot vent gas in one or more selected directions. The diverter includes a diverter sidewall and a diverter cap. The one or more diverter openings are positioned in the diverter sidewall. A protrusion extends from the diverter cap toward a vent opening of the plurality of vent openings. The protrusion is configured to control a chamber velocity of the vent gas. The protrusion is conical in shape.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic illustration of an embodiment of a vehicle;

FIG. 2 is a cross-sectional illustration of a rechargeable energy storage system (RESS) of a vehicle;

FIG. 3 is a perspective view of an embodiment of a diverter for an RESS;

FIG. 4, is an exemplary cross-sectional view of the embodiment of FIG. 3;

FIG. 5 is a perspective view of another embodiment of a diverter for an RESS;

FIG. 6 is an exemplary cross-sectional view of the embodiment of FIG. 5;

FIG. 7 illustrates yet another exemplary embodiment of a diverter for an RESS;

FIG. 8 is an exemplary cross-sectional view of the embodiment of FIG. 7;

FIG. 9 illustrates yet another exemplary embodiment of a diverter for an RESS;

FIG. 10 illustrates still another exemplary embodiment of a diverter for an RESS;

FIG. 11 is an exemplary cross-sectional view of the embodiment of FIG. 10; and

FIG. 12 is an exemplary cross-sectional view of another embodiment of a diverter for an RESS.

### DETAILED DESCRIPTION

The following description is merely exemplary in nature and is not intended to limit the present disclosure, its application or uses. It should be understood that throughout the drawings, corresponding reference numerals indicate like or corresponding parts and features.

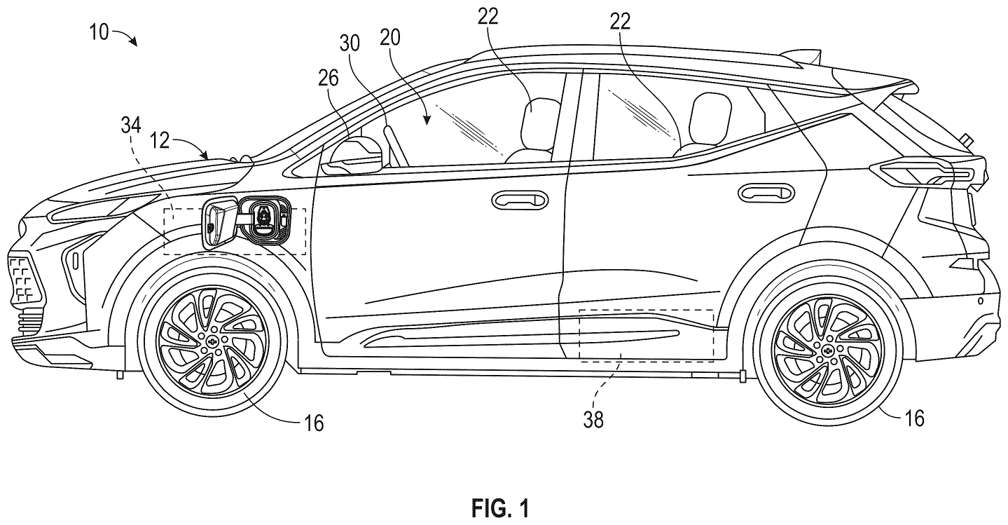

In accordance with an exemplary embodiment a vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. Body 12 defines, in part, a passenger compartment 20 having seats 22 positioned behind a dashboard 26. A steering control 30 is arranged between seats 22 and dashboard 26. Steering control 30 is operated to control orientation of the steerable wheel(s). Vehicle 10 includes an electric motor 34 connected to a transmission that provides power to one or more of the plurality of wheels 16. A rechargeable energy storage system (RESS) assembly 38 provides power to the electric motor 34.

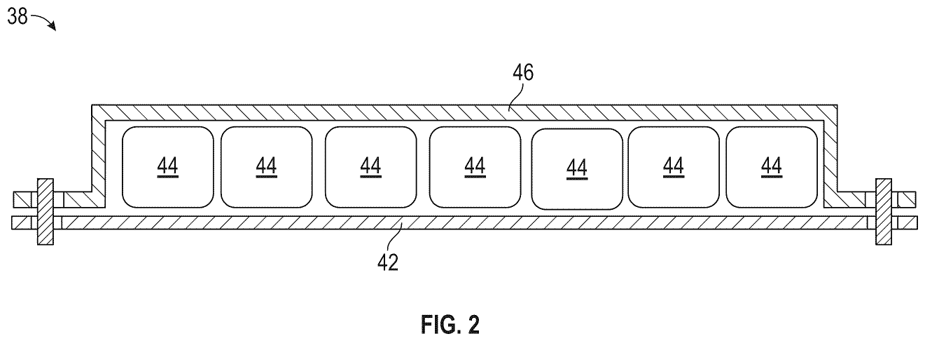

Referring now to FIG. 2, illustrated is a cross-sectional view of an exemplary embodiment of an RESS assembly 38. The RESS assembly 38 includes a tray 42 with a plurality of cells 44 disposed therein. To enclose the RESS assembly 38, a cover 46 is installed thereto. Under some conditions, at least one of the plurality of cells 44 may emit a high temperature gas, such as during a thermal propagation event of the RESS assembly 38. It is desired to direct the emitted gas away from the cells 44, to prevent the heating of the cells 44 and to prevent damage to surrounding components, such as the cover 46.

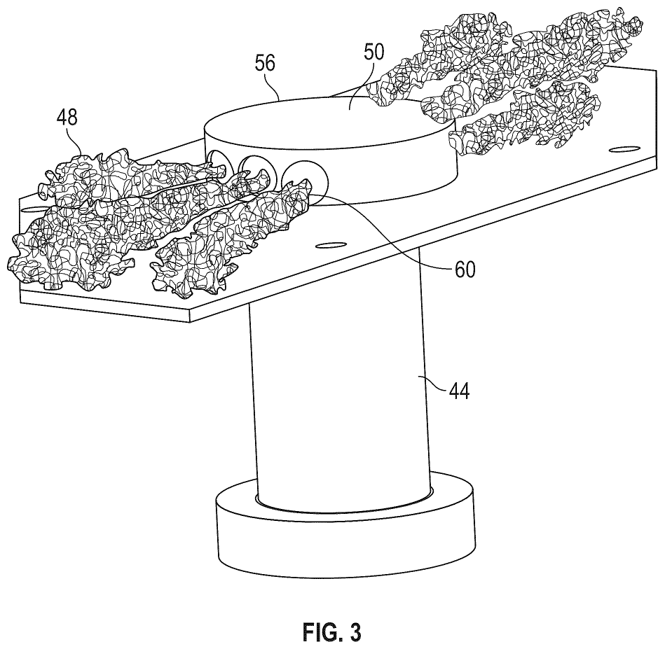

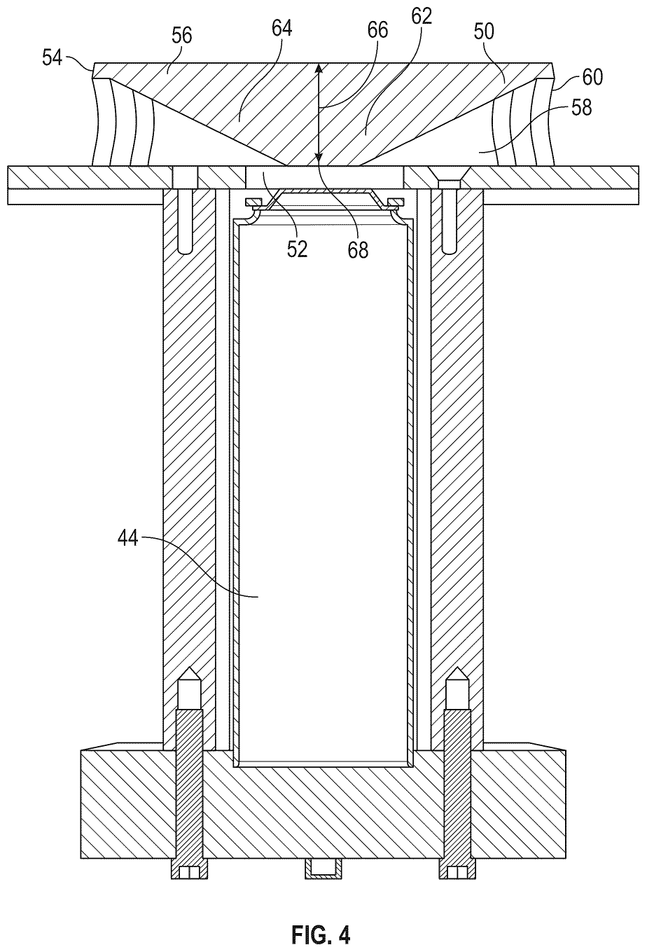

Referring now to FIGS. 3 and 4, to direct vent gas 48 away from the battery cells 44, one or more diverters 50 is installed at a vent opening 52 of the battery cell 44. In the embodiment of FIGS. 3 and 4, the battery cell 44 is a cylindrical battery cell 44, but one skilled in the art will readily appreciate that the present disclosure may be readily applied to other cell 44 configurations, such as prismatic battery cells 44. The diverter 50 is positioned at a cell end 62 of the battery cell 44 and is, for example, cylindrical in shape and includes a sidewall 54 and a cap 56 defining a diverter chamber 58. The diverter 50 is positioned to cover the vent opening 52 of the battery cell 44. A plurality of sidewall openings 60 are located in the sidewall 54 to exhaust vent gas 48 out of the diverter chamber 58 in selected directions to direct the vent gas 48 away from selected surrounding components, and to cool the vent gas 48 by encouraging mixing of the hot vent gas 48 with cooler ambient air present outside of the diverter 50. As shown best in FIG. 4, the diverter 50 includes a protrusion 64 extending into the diverter chamber 58 from the cap 56 toward the vent opening 52 at the cell end 62 of the battery cell 44. The protrusion 64 is, for example, conical in shape and includes a protrusion height 66 defined as a distance of a protrusion tip 68 from the cap 56. The protrusion height 66 is sized to produce a selected initial chamber velocity of the vent gas 48 by restricting the flow area inside the diverter chamber 58 and directing the vent gas 48 toward the plurality of sidewall openings 60. The plurality of sidewall openings 60 are sized and arranged to produce a selected exit velocity and mass flow of the vent gas 48. The number of sidewall openings 60 are selected and directed to enhance mixing of the vent gas 48 with ambient air and therefore improve cooling efficiency.

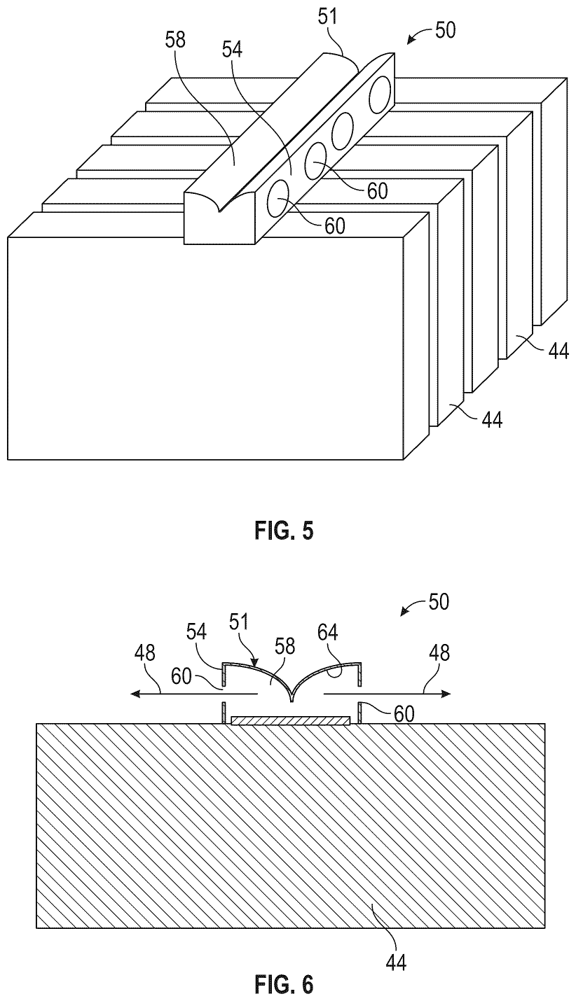

Referring now to FIGS. 5 and 6, in another embodiment, the diverter 50 spans a plurality of battery cells 44 and includes a shared diverter chamber 58 common to the plurality of battery cells 44. In the illustrated embodiment, the diverter 50 is rectangular in shape including sidewall openings 60 in at least one sidewall 54 of the diverter 50. Referring to FIG. 6, the protrusion 64 may be a curved surface at an upper wall 51 of the diverter 50, which is configured to direct the vent gas 48 out of the sidewall openings 60. The shared diverter chamber 58 improves performance of the diverter 50 by allowing for directing the vent gas 48 from one battery cell 44 out of sidewall openings 60 all along the diverter chamber 58, not only those sidewall openings 60 located at the particular battery cell 44. This reduces back pressure in the diverter chamber 58.

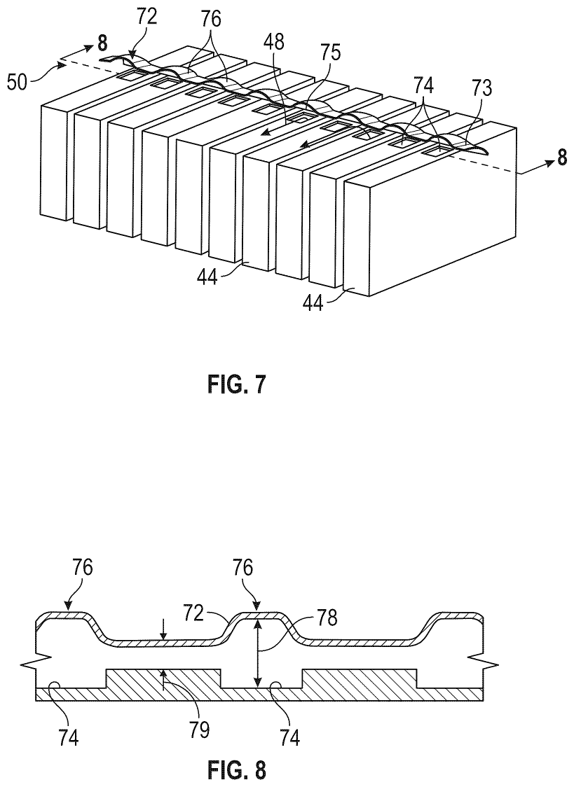

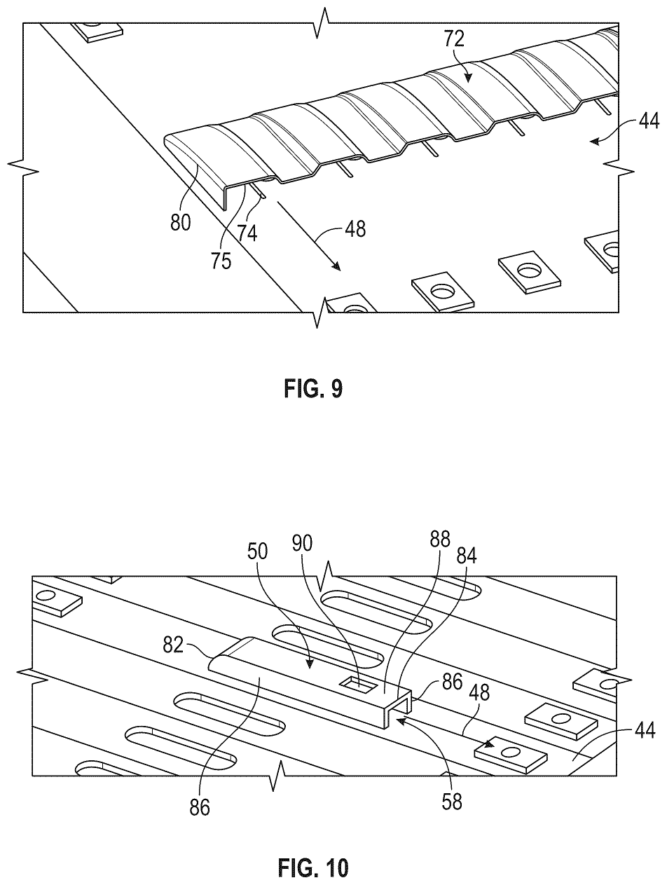

In another embodiment, illustrated in FIGS. 7 and 8, the diverter 50 is an inclined panel 72 positioned over the battery cells 44 to divert the vent gas 48 flowing out of the battery cells 44 via cell vents 74. The panel 72 spans a plurality of battery cells 44 and includes a plurality of panel undulations 76 arranged such that a panel distance 78 from the battery cell 44 is greater at the cell vents 74 than the panel spacing 79 between cell vents 74. In some embodiments, the panel 72 is secured to the battery cells 44 at a first, upstream end 73 and directs the vent gas 48 away from the cell vents 74 in a downstream direction 75, opposite the upstream end 73. This configuration allows for spreading of the vent gas 48 over a greater length along the battery cells 44 to improve dissipation of thermal energy from the vent gas 48. Additionally, in some embodiments, as illustrated in FIG. 9, the panel 72 may be secured to the battery cells 44 at one or more lateral panel ends 80 of the panel 72. This further directs the vent gas 48 in a selected flow direction.

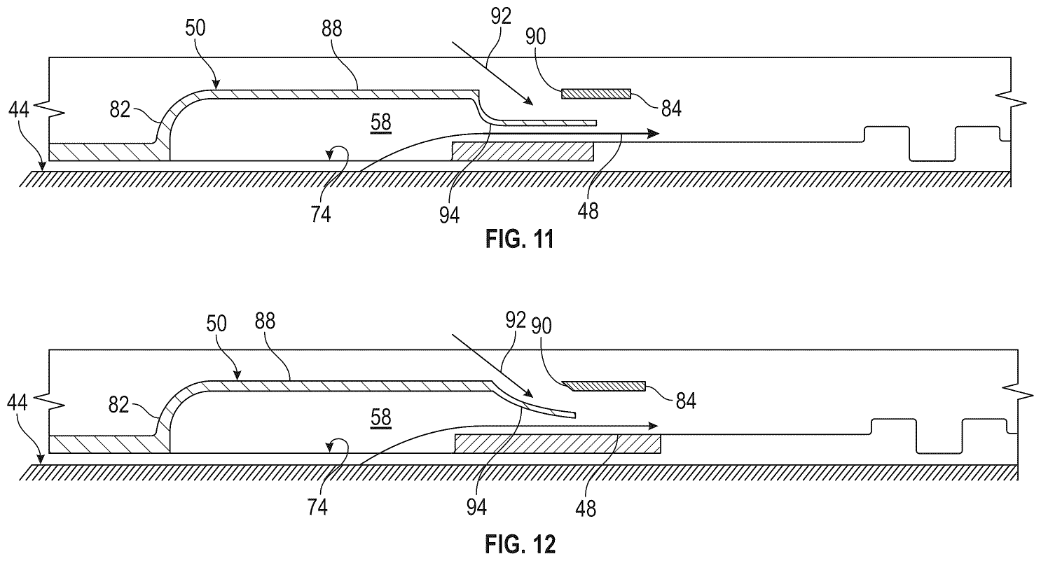

Another embodiment of a diverter 50 is illustrated in FIGS. 10 and 11. In this embodiment, the diverter 50 includes a closed end 82 and an open end 84 opposite the closed end 82, through which the vent gas 48 is directed from the battery cell 44. The diverter 50 may further include one or more lateral sidewalls 86. A top wall 88, which is disposed between the lateral sidewalls 86 and extends from the closed end 82 to the open end 84 and defines the diverter chamber 58 between the battery cell 44 and the top wall 88. The top wall 88 includes a top wall opening 90. The top wall opening 90 enables relatively low temperature ambient air 92, as illustrated in FIG. 11, to be drawn into the diverter chamber 58 for mixing with the vent gas 48 inside of the diverter chamber 58 prior to the vent air flowing out of the open end 84. In some embodiments, such as illustrated in FIG. 12, a flow guide 94 is disposed inside of the top wall opening 90, and is shaped to direct additional ambient air 92 into the diverter chamber 58. In some embodiments, the flow guide 94 has a curvilinear shape.

The disclosed diverter 50 configurations reduce the temperature of the hot vent gas at the exit of diverter itself which will help in saving nearby components during a thermal propagation event. The diverter chamber 58 enhances cooling through turbulent mixing of vent gas plumes with the surrounding cooler ambient air. The diverter chamber design controls the vent gas plume distribution through adjusting hole size, shape, and arrangement. Auto-ignition of the vent gas within the diverter chamber 58 can be eliminated by adjusting its internal volume to increase the initial vent gas velocity greater than 30 m/s. Additionally, the diverter chamber 58 internal volume can be adjusted to trap vented solid particles.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on”another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A rechargeable energy storage system (RESS) of a vehicle, comprising:
a plurality of battery cells, the plurality of battery cells including a plurality of vent openings to exhaust hot vent gas from the plurality of battery cells; and
a diverter disposed at at least one cell vent of the plurality of cell vents and defining a diverter chamber, the diverter including one or more diverter openings to direct the hot vent gas in one or more selected directions.

2. The RESS of claim 1, wherein the diverter includes:
a diverter sidewall; and
a diverter cap;
wherein the one or more diverter openings are disposed in the diverter sidewall.

3. The RESS of claim 2, further comprising a protrusion extending from the diverter cap toward a vent opening of the plurality of vent openings, the protrusion configured to control a chamber velocity of the vent gas.

4. The RESS of claim 3, wherein the protrusion is conical in shape.

5. The RESS of claim 1, wherein the diverter spans two or more vent openings of the plurality of vent openings.

6. The RESS of claim 5, wherein the diverter is an inclined panel disposed at the two or more vent openings.

7. The RESS of claim 6, wherein the inclined panel has a first panel distance from the battery cells to the inclined panel at a vent opening of the two or more vent openings greater than a second panel distance from the battery cells to the inclined panel between the two or more vent openings.

8. The RESS of claim 6, wherein the inclined panel is secured to the two or more battery cells at at least one panel end.

9. The RESS of claim 1, wherein the diverter includes:
a top wall; and
two opposing side walls, the top wall and side walls defining the diverter chamber and the one or more diverter openings;
wherein the top wall includes at least one top wall opening configured to admit relatively cool ambient airflow into the diverter chamber for mixing with the hot vent gas.

10. The RESS of claim 9, further comprising a flow guide disposed in the at least one top wall opening to guide the ambient airflow thereinto.

11. A vehicle, comprising:
a vehicle body;
a powertrain disposed in the vehicle body; and
a rechargeable energy storage system (RESS) operably connected to the powertrain, the RESS including:
a plurality of battery cells, the plurality of battery cells including a plurality of vent openings to exhaust hot vent gas from the plurality of battery cells; and
a diverter disposed at at least one vent opening of the plurality of vent openings and defining a diverter chamber, the diverter including one or more diverter openings to direct the hot vent gas in one or more selected directions.

12. The vehicle of claim 11, wherein the diverter includes:
a diverter sidewall; and
a diverter cap;
wherein the one or more diverter openings are disposed in the diverter sidewall.

13. The vehicle of claim 12, further comprising a protrusion extending from the diverter cap toward a vent opening of the plurality of vent openings, the protrusion configured to control a chamber velocity of the vent gas.

14. The vehicle of claim 13, wherein the protrusion is conical in shape.

15. The vehicle of claim 11, wherein the diverter spans two or vent openings of the plurality of vent openings.

16. The vehicle of claim 15, wherein the diverter is an inclined panel disposed at the two or more vent openings.

17. The vehicle of claim 16, wherein the inclined panel has a first panel distance from the battery cells to the inclined panel at a vent opening of the two or more vent openings greater than a second panel distance from the battery cells to the inclined panel between the two or more vent openings.

18. The vehicle of claim 16, wherein the inclined panel is secured to the battery cells at at least one panel end.

19. The vehicle of claim 11, wherein the diverter includes:
a top wall; and
two opposing side walls, the top wall and side walls defining the diverter chamber and the one or more diverter openings;
wherein the top wall includes at least one top wall opening configured to admit relatively cool ambient airflow into the diverter chamber for mixing with the hot vent gas.

20. A vehicle, comprising:
a vehicle body defining a passenger compartment;
a powertrain disposed in the vehicle body; and
a rechargeable energy storage system (RESS) operably connected to the powertrain, the RESS including:
a plurality of battery cells, the plurality of battery cells including a plurality of vent openings to exhaust hot vent gas from the plurality of battery cells; and
a diverter disposed at at least one vent opening of the plurality of vent openings and defining a diverter chamber, the diverter including one or more diverter openings to direct the hot vent gas in one or more selected directions;
wherein the diverter includes:
a diverter sidewall; and
a diverter cap;
wherein the one or more diverter openings are disposed in the diverter sidewall;
wherein a protrusion extends from the diverter cap toward a vent opening of the plurality of vent openings, the protrusion configured to control a chamber velocity of the vent gas; and
wherein the protrusion is conical in shape.
